(19) United States
(12) Patent Application Publication
(10) Pub. No.: US 2013/0257689 A1
(43) Pub. Date: Oct. 3, 2013

(54) DISPLAY DEVICE

(71) Applicant: KABUSHIKI KAISHA TOSHIBA, Tokyo (JP)

(72) Inventors: Aira Hotta, Kanagawa-ken (JP); Minoru Inomoto, Kanagawa-ken (JP); Haruhiko Okumura, Kanagawa-ken (JP)

(73) Assignee: KABUSHIKI KAISHA TOSHIBA, Tokyo (JP)

(21) Appl. No.: 13/766,868

(22) Filed: Feb. 14, 2013

(30) Foreign Application Priority Data
Mar. 28, 2012 (JP) 2012-075036

(51) Int. Cl. G02B 27/01

(52) U.S. Cl. CPC G02B 27/0172
USPC 345/8

(57) ABSTRACT

According to one embodiment, a display device includes an image projection unit, a diffusion element, a concave mirror element of a Fresnel type, an optical unit, and a mounting unit. The image projection unit emits an image light including an image. The diffusion element is diffusible to a light. The optical unit includes first and second optical layers, and an intermediate layer. The first optical layer has first and second major surfaces. The second major surface has a protrusion and convexities. The second optical layer has third and fourth major surfaces. The third major surface has a recess and concavities. The intermediate layer is provided between the second and third major surfaces. The mounting unit holds the image projection unit, the diffusion element, the concave mirror element, and the optical unit and determines a relative positional relationship between the optical unit and an eye of a viewer.

### CROSS-REFERENCE TO RELATED APPLICATIONS

This application is based upon and claims the benefit of priority from the prior Japanese Patent Application No. 2012-075036, filed on Mar. 28, 2012; the entire contents of which are incorporated herein by reference.

### FIELD

Embodiments described herein relate generally to a display device.

### BACKGROUND

A head-mounted display is developed that is mounted on the head of a user (viewer) and performs displaying on an eye of the user. For example, a display device is proposed in which a reflection surface is provided on the back surface of a transparent member and the light reflected at the reflection surface is guided to an eye of a user.

For such a display device, it is desired to be easy to view, small in size, and light in weight.

### BRIEF DESCRIPTION OF THE DRAWINGS

FIG. 1 is a schematic view showing a display device according to a first embodiment;

FIG. 2A to FIG. 2D are schematic views showing the display device according to the first embodiment;

FIG. 3A to FIG. 3C are schematic views showing a part of the display device according to the first embodiment;

FIG. 4 is a schematic view showing another display device according to the first embodiment;

FIG. 5 is a schematic cross-sectional view illustrating another display device according to the first embodiment;

FIG. 6 is a schematic view showing a display device according to a second embodiment;

FIG. 7A and FIG. 7B are schematic views showing the display device according to the second embodiment; and

FIG. 8 is a schematic view showing a display device according to the embodiment.

### DETAILED DESCRIPTION

According to one embodiment, a display device includes an image projection unit, a diffusion element, a concave mirror element of a Fresnel type, an optical unit, and a mounting unit. The image projection unit is configured to emit an image light including an image. The diffusion element is diffusible to a light. The optical unit includes a first optical layer, a second optical layer, and an intermediate layer. The first optical layer has a first major surface and a second major surface on an opposite side to the first major surface. The second major surface has a protrusion having a curved surface and a plurality of convexities provided around the protrusion. The first optical layer is transmissive to a light. The second optical layer has a third major surface and a fourth major surface. The third major surface is opposed to the second major surface. The fourth major surface is on an opposite side to the third major surface. The third major surface has a recess recessed along a shape of the protrusion and a plurality of concavities provided around the recess. A shape of each of the concavities conforms to a shape of each of the convexities. The second optical layer is transmissive to a light. The intermediate layer is provided between the second major surface and the third major surface. The intermediate layer is configured to reflect at least a part of a light traveling from the first major surface toward the second major surface and to transmit at least a part of a light traveling from the fourth major surface toward the third major surface. The mounting unit holds the image projection unit, the diffusion element, the concave mirror element, and the optical unit so as to allow the image light emitted from the image projection unit to pass through the diffusion element, cause the image light emitted from the diffusion element to be reflected at the concave mirror element, and cause the image light reflected at the concave mirror element to enter the optical unit from the first major surface and is configured to determine a relative positional relationship between the optical unit and an eye of a viewer so that a reflected light obtained by reflection of the image light entering the optical unit at the intermediate layer is emitted from the first major surface and is incident on the eye of the viewer.

According to another embodiment, a display device includes an image projection unit, a diffusion element, an optical unit, and a mounting unit. The image projection unit is configured to emit an image light including an image. The diffusion element has a front surface in a convex curved surface shape being diffusible to a light. The optical unit includes a first optical layer, a second optical layer, and an intermediate layer. The first optical layer has a first major surface and a second major surface on an opposite side to the first major surface. The second major surface has a protrusion having a curved surface and a plurality of convexities provided around the protrusion. The first optical layer is transmissive to a light. The second optical layer has a third major surface and a fourth major surface. The third major surface is opposed to the second major surface. The fourth major surface is on an opposite side to the third major surface. The third major surface has a recess recessed along a shape of the protrusion and a plurality of concavities provided around the recess. A shape of each of the concavities conforms to a shape of each of the convexities. The second optical layer is transmissive to a light. The intermediate layer is provided between the second major surface and the third major surface. The intermediate layer is configured to reflect at least a part of alight traveling from the first major surface toward the second major surface and to transmit at least a part of a light traveling from the fourth major surface toward the third major surface. The mounting unit holds the image projection unit, the diffusion element, and the optical unit so as to allow the image light emitted from the image projection unit to pass through the front surface and enter the optical unit from the first major surface and is configured to determine a relative positional relationship between the optical unit and an eye of a viewer so that a reflected light obtained by reflection of the image light entering the optical unit at the intermediate layer is emitted from the first major surface and is incident on the eye of the viewer.

Various embodiments will be described hereinafter with reference to the accompanying drawings.

The drawings are schematic or conceptual; and the proportions of sizes among portions, etc. are not necessarily the same as the actual values thereof. Further, the dimensions and proportions may be illustrated differently among drawings, even for identical portions.

In the specification of this application and the drawings, components similar to those described in regard to a drawing thereinabove are marked with the same reference numerals, and a detailed description is omitted as appropriate.

### First Embodiment

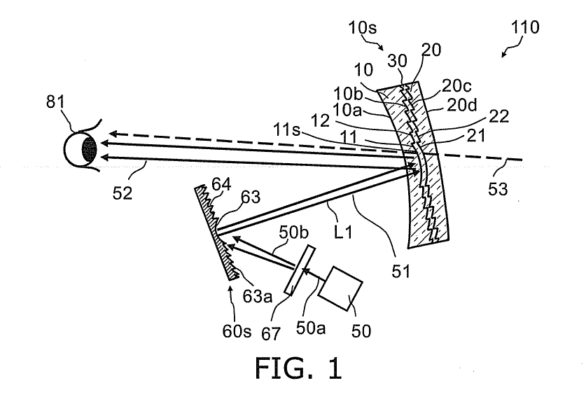

FIG. 1 is a schematic view illustrating a display device according to a first embodiment.

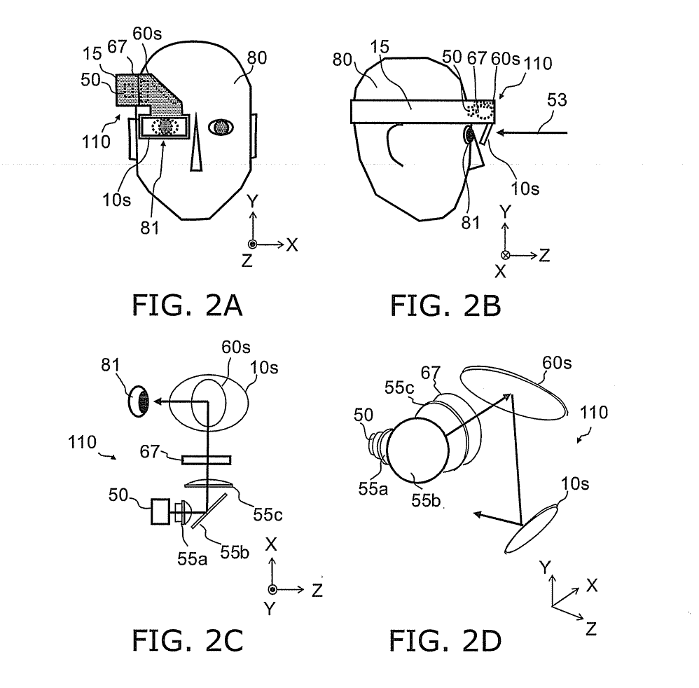

FIG. 2A to FIG. 2D are schematic views illustrating the display device according to the first embodiment.

FIG. 2A is a front view, and FIG. 2B is a side view. FIG. 2C is a top view illustrating the arrangement of optical elements.

FIG. 2D is a schematic perspective view illustrating optical elements included in the display device.

As shown in FIG. 2A and FIG. 2B, a display device 110 according to the embodiment includes an image projection unit 50, a diffusion element 67, a concave mirror element 60s, an optical unit 10s, and a mounting unit 15.

The mounting unit 15 holds the image projection unit 50, the diffusion element 67, the concave mirror element 60s, and the optical unit 10s. The image projection unit 50, the diffusion element 67, the concave mirror element 60s, and the optical unit 10s are mounted on the mounting unit 15. The mounting unit 15 determines the relative positional relationship between the optical unit 10s and an eye 81 of a viewer 80. The viewer 80 is a user of the display device 110.

As shown in FIG. 2B, the viewer 80 can view the background image included in the transmitted light 53 transmitted through the optical unit 10s. The display device 110 is, for example, an optical see-through head-mounted display device.

The direction from back to front as viewed from the viewer 80 is defined as, for example, the Z-axis direction. The vertical direction of the viewer 80 is defined as, for example, the Y-axis direction. The lateral direction of the viewer 80 is defined as the X-axis direction.

FIG. 1 illustrates cross sections of the concave mirror element 60s and the optical unit 10s.

As shown in FIG. 1, the image projection unit 50 emits image light 50a including an image. The image light 50a is, for example, laser light. The image light 50a is incident on the diffusion element 67. The diffusion element 67 is diffusible to light. The width of the light flux (the width of the cross section of the light flux taken along a plane perpendicular to the axis of the light flux) of the light (image light 50b) emitted from the diffusion element 67 is larger than the width of the light flux of the image light 50a incident on the diffusion element 67. The diffusion element 67 expands the diffusion angle of the incident light.

The concave mirror element 60s is a Fresnel type. The concave mirror element 60s has, for example, a mirror major surface 63a. The mirror major surface 63a has a recess 63 in a concave curved surface shape and a plurality of concavities 64 provided around the recess 63. For example, each of the plurality of concavities 64 is provided in a form of a circle concentric with the recess 63. Each of the plurality of concavities 64 is provided in a form of a concentric circle (including a flat circle) with center at the center of the recess 63. The concave mirror element 60s is reflective to light.

The optical unit 10s includes a first optical layer 10, a second optical layer 20, and an intermediate layer 30.

The first optical layer 10 has a first major surface 10a and a second major surface 10b. The second major surface 10b is a surface on the opposite side to the first major surface 10a. The second major surface 10b has a protrusion 11 and a plurality of convexities 12. The protrusion 11 has a surface 11s in a curved surface shape. The plurality of convexities 12 are provided around the protrusion 11. The first optical layer 10 is transmissive to light.

The second optical layer 20 has a third major surface 20c and a fourth major surface 20d. The third major surface 20c is opposed to the second major surface 10b. The fourth major surface 20d is a surface on the opposite side to the third major surface 20c. The third major surface 20c has a recess 21 and a plurality of concavities 22. The recess 21 is recessed along the shape of the protrusion 11. That is, the recess 21 is recessed along the protrusion direction of the protrusion 11. The plurality of concavities 22 are provided around the recess 21. The shape of each of the plurality of concavities 22 conforms to the shape of each of the plurality of convexities 12. The second optical layer 20 is transmissive to light.

The intermediate layer 30 is provided between the second major surface 10b and the third major surface 20c. The intermediate layer 30 reflects at least part of the light L1 traveling from the first major surface 10a toward the second major surface 10b (e.g. image light 51). At least part of the light L1 reflected at the intermediate layer 30 is emitted from the first major surface 10a via the first optical layer 10. The intermediate layer 30 transmits at least part of the light L2 traveling from the fourth major surface 20d toward the third major surface 20c (e.g. the transmitted light 53).

The mounting unit 15 holds the image projection unit 50, the diffusion element 67, the concave mirror element 60s, and the optical unit 10s so as to allow the image light 50a emitted from the image projection unit 50 to pass through the diffusion element 67, cause the image light 50b emitted from the diffusion element 67 to be reflected at the concave mirror element 60s, and cause the image light 51 reflected at the concave mirror element 60s to enter the optical unit 10s from the first major surface 10a. The mounting unit 15 determines the relative positional relationship between the optical unit 10s and the eye 81 of the viewer 80 so that the reflected light 52 obtained by the reflection of the image light 51 entering the optical unit 10s at the intermediate layer 30 may be emitted from the first major surface 10a and be incident on the eye 81 of the viewer 80.

In the display device 110, the protrusion 11 provided at the second major surface 10b is protruded, and the recess 21 provided at the third major surface 20c is recessed. Each of the plurality of convexities 12 surrounds the protrusion 11. Each of the plurality of convexities 12 is concentric with the protrusion 11. Each of the plurality of convexities 12 is provided in a form of a concentric circle (including a flat circle) with center at the center of the protrusion 11. Each of the plurality of concavities 22 is provided in a form of a circle concentric with the recess 21. Each of the plurality of concavities 22 is provided in a form of a concentric circle (including a flat circle) with center at the center of the recess 21.

The second major surface 10b has a configuration of a Fresnel lens surface. In the second major surface 10b, the protrusion 11 and the plurality of convexities 12 form the surface of the Fresnel lens. The third major surface 20c has a configuration of a Fresnel lens surface. In the third major surface 20c, the recess 21 and the plurality of concavities 22 form the surface of the Fresnel lens.

Thereby, the intermediate layer 30 functions as a concave mirror having a Fresnel lens configuration. The image included in the reflected light 52 obtained by the reflection at the intermediate layer 30 is larger than the image included in the image light 51. That is, the image is magnified at the intermediate layer 30. Thereby, the display device 110 can provide an easy-to-view display for the viewer 80. That is, the optical unit 10s functions as a Fresnel half mirror.

Since the second major surface 10b has a configuration of a Fresnel lens surface and the third major surface 20c has a configuration of a Fresnel lens surface, the thickness of the entire optical unit 10s can be made thin while the curvature of the entire concave mirror of the intermediate layer 30 is made (kept) great.

Thereby, a small, light display device capable of providing an easy-to view display is obtained without using a correction lens etc.

On the other hand, when a Fresnel half mirror (the optical unit 10s) is used as the eyepiece, the imaging surface of the image projected is warped. If a correction lens is used in order to correct this, the number of parts is increased and the size and weight of the entire device are increased.

In contrast, in the display device 110 according to the embodiment, a correction lens can be omitted by using a Fresnel half mirror (the optical unit 10s) and the concave mirror element 60s in combination. The display device 110 can provide an easy-to-view, small, light display device. A smaller, lighter display device can be provided by using the concave mirror element 60s of a Fresnel type.

In the display device 110, the diffusion element 67 is provided as a diffusion control unit for controlling the diffusion of the image light 50a. The depth of focus is deepened by providing the diffusion control unit. Furthermore, at the eye 81, a range in which images are seen can be ensured even when there are eye movements.

In the display device 110, the warpage of the imaging surface due to the Fresnel half mirror (the optical unit 10s) is suppressed by using the concave mirror element 60s of a Fresnel type. Thereby, a small, light display device capable of providing an easy-to-view display is obtained without using a correction lens.

Thus, the warpage of the imaging surface can be suppressed by using a Fresnel half mirror and a Fresnel mirror in combination.

On the optical path of the image light 50a emitted from the image projection unit 50, various optical elements may be provided between the image projection unit 50 and the diffusion element 67.

For example, as illustrated in FIG. 2C and FIG. 2D, a first lens element 55a may be provided between the image projection unit 50 and the diffusion element 67, a mirror 55b may be provided between the first lens element 55a and the diffusion element 67, and a second lens element 55c may be provided between the mirror 55b and the diffusion element 67. The volume of the entire device can be reduced by bending the optical path using the mirror 55b.

For the first optical layer 10 and the second optical layer 20, glass, resin, or the like transmissive to visible light is used.

For the intermediate layer 30, for example, a metal film (e.g. an aluminum film etc.), a metal compound film, or the like is used. By thinning the thickness of the intermediate layer 30 sufficiently, the intermediate layer 30 reflects the image light 51 and transmits the transmitted light 53.

Also a reflection transmission film formed of a multiple-layer stacked film or the like, for example, may be used as the intermediate layer 30. The multiple-layer stacked film has, for example, wavelength selectivity. The intermediate layer 30 may include, for example, a plurality of first layers and a second layer provided between first layers and having a refractive index different from the refractive index of the plurality of first layers. Also in this case, the intermediate layer 30 reflects the image light 51 and transmits the transmitted light 53.

The transmittance of the intermediate layer 30 to visible light (e.g. green light, for example, light having a wavelength of 550 nm) is preferably, for example, 90% or more (the reflectance is preferably less than 10%). If the transmittance of the intermediate layer 30 is excessively low, the transmitted light 53 does not reach the eye 81 sufficiently. By setting the transmittance of the intermediate layer 30 to 90% or more, a bright actual scene (an image in the actual space, i.e., a background image) is obtained.

In the embodiment, the refractive index of the first optical layer 10 is preferably the same as the refractive index of the second optical layer 20. For example, the absolute value of the difference between the refractive index of the first optical layer 10 and the refractive index of the second optical layer 20 is preferably 1×10⁻³ or less. Thereby, the warpage of the background image included in the transmitted light 53 can be effectively suppressed.

The pitch (the pitch of the plurality of concavities 64) of the concave mirror element 60s (a Fresnel mirror) is preferably approximately equal to the pixel pitch of the image (the image light 50a) reflected at the optical unit 10s (a Fresnel half mirror).

An example of the specifications of the display device 110 is as follows. The horizontal resolution (the number of pixels in the horizontal direction) is 800, and the vertical resolution (the number of pixels in the vertical direction) is 480. The virtual image distance is 2500 millimeters (mm). The horizontal angle of view is 20 degrees. The eye range (minimum) is 10 mm. The distance between the pupil and the mirror (the optical unit 10s, a Fresnel half mirror) is 15 mm. At this time, for example, the pitch (the pitch of the plurality of concavities 64) of the concave mirror element 60s (a Fresnel mirror) is approximately 5 μm. In this case, the pitch of the plurality of concavities 64 of the concave mirror element 60s is substantially equal to the pixel pitch, and good image quality is obtained.

An excessively short pitch in the Fresnel lens structure reduces the image quality due to the influence of diffraction. By setting the pitch in the Fresnel lens structure approximately equal to the pixel pitch, the decrease in image quality can be substantially suppressed.

An excessively long pitch of the Fresnel lens structure makes the plurality of convexities 12 or the plurality of concavities 22 conspicuous and reduces the image quality. If the pitch of the Fresnel lens structure is approximately 10 times or less the pixel pitch, the concavo-convex structure is conspicuous. In the embodiment, the pitch of the Fresnel lens structure (e.g. the distance between two nearest convexities 12 out of the plurality of convexities 12) is preferably not less than ½ and not more than 10 times the pitch of the pixel of the image light 51. The pitch of the pixel of the image light 51 is, for example, the pitch of the pixel on the optical unit 10s (a Fresnel half mirror) of the image light 51.

Similarly, in the concave mirror element 60s (a Fresnel mirror), the pitch of the Fresnel lens structure (e.g. the distance between two nearest concavities 64 out of the plurality of concavities 64) is preferably not less than ½ and not more than 10 times the pitch of the pixel of the image light 51. In this case, the pitch of the pixel of the image light 51 is, for example, the pitch of the pixel on the concave mirror element 60s (a Fresnel mirror) of the image light 51.

The distance between the first major surface 10a of the optical unit and the eye 81 of the viewer 80 is, for example, not less than 5 mm and not more than 30 mm. When the distance between the first major surface 10a and the eye 81 of the viewer 80 is thus short, since the eye is out of focus, the reduction in image quality due to the broadness of the pitch is a practically acceptable level at pitches of, for example, 1000 μm or less.

In the embodiment, the curvature of the first major surface 10a may be set different from the curvature of the fourth major surface 20d. Thereby, for example, the optical unit 10s functions similarly to common glasses for the background image of the outside. At the same time, the optical unit 10s functions as a reflection screen for the display image projected. Thereby, a display with little distortion and a wide visual field can be obtained. In particular, good images can be provided for the viewer 80 in AR displays.

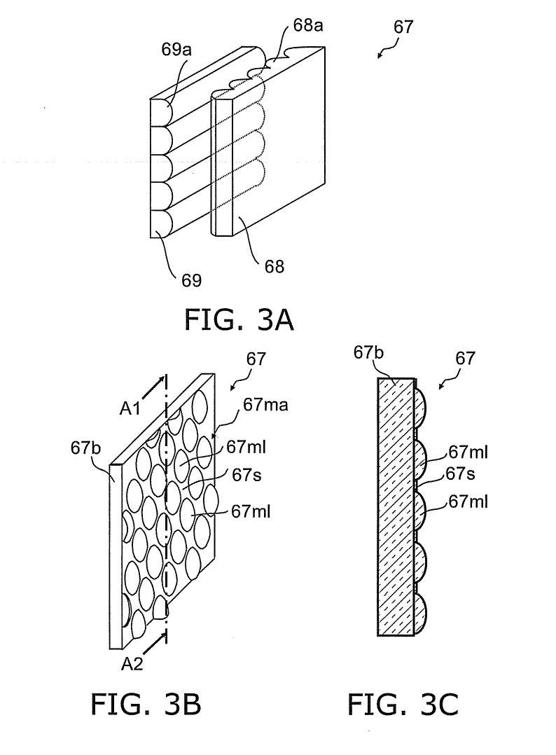

FIG. 3A to FIG. 3C are schematic views illustrating part of the display device according to the first embodiment.

FIG. 3A and FIG. 3B are schematic perspective views. FIG. 3C is a cross-sectional view taken along line A1-A2 of FIG. 3B. The drawings show examples of the diffusion element 67.

As shown in FIG. 3A, the diffusion element 67 may include a first lenticular lens 68 and a second lenticular lens 69. The first lenticular lens 68 has a plurality of convexities 68a (first lenticular convexities) extending in a first direction. The convexity 68a has a substantially semicircular cylindrical shape. The axis of the circular cylinder extends in the first direction. The second lenticular lens 69 has a plurality of convexities 69a (second lenticular convexities) extending in a second direction. The second direction is substantially perpendicular to the first direction. The convex 69a has a substantially semicircular cylindrical shape. The axis of the circular cylinder extends in the second direction. Thus, two lenticular lenses of which the axes are perpendicularly combined may be used as the diffusion element 67. By this configuration, diffusion can be controlled with high accuracy by a simple configuration.

The pitch of the lenticular lens is preferably substantially equal to the pixel size (e.g. not less than 75% and not more than 125% of the pixel pitch). For example, the pitch of the lenticular lens is not less than 20 μm and not more than 30 μm. It is found that good images are obtained in this case. In an example, the pitch of the lenticular lens is 0.03 mm, the curvature radius is 0.05 mm, and the divergence angle δ is 8.6 degrees.

As shown in FIG. 3B and FIG. 3C, a microlens array 67ma may be used as the diffusion element 67. The microlens array 67ma has a base substance 67b and a plurality of lenses 67ml provided on the surface of the base substance 67b. When the microlens array 67ma is used as the diffusion element 67, the necessary diffusion characteristics can be obtained by one sheet. At this time, the pitch of the microlens array 67ma (the pitch of the plurality of lenses 67ml) is preferably substantially equal to the pixel size (e.g. not less than 75% and not more than 125% of the pixel pitch). The pitch of the microlens array 67ma is, for example, not less than 20 μm and not more than 30 μm.

In the microlens array 67ma, a light blocking layer 67s may be provided in a flat portion between lenses 67ml. Thereby, the light leakage from the flat portion between lenses 67ml can be suppressed. Thus, higher quality images can be obtained.

By using the diffusion element 67 described in regard to FIG. 3A to FIG. 3C, a small, light display device capable of providing an easy-to-view display is obtained. However, in the embodiment, the configuration of the diffusion element 67 is arbitrary.

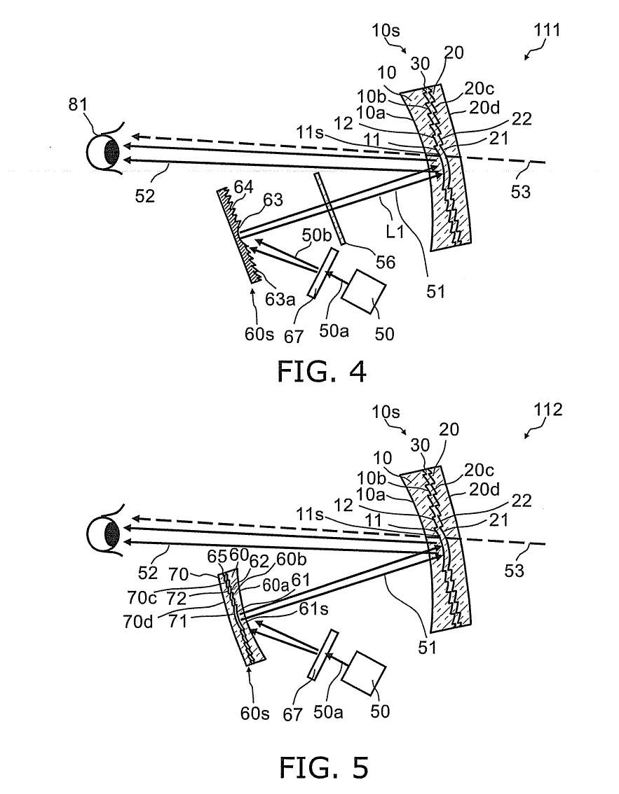

FIG. 4 is a schematic view illustrating another display device according to the first embodiment.

As shown in FIG. 4, a display device 111 according to the embodiment further includes a cylindrical lens 56. The cylindrical lens 56 is disposed between the concave mirror element 60s and the optical unit 10s on the optical path.

In the case where, for example, light is incident on the concave mirror element 60s (a Fresnel mirror element) from a direction inclined with respect to the major surface of the concave mirror element 60s, astigmatism may occur depending on the incident angle. At this time, the astigmatism can be corrected using the cylindrical lens 56.

The recess 63 and the plurality of concavities 64 of the concave mirror element 60s (a Fresnel mirror) may be configured to have a flat circular (elliptical) planar shape; thereby, the astigmatism mentioned above can be suppressed.

FIG. 5 is a schematic cross-sectional view illustrating another display device according to the first embodiment.

As shown in FIG. 5, in a display device 112 according to the embodiment, a similar configuration to the optical unit 10s is used as the concave mirror element 60s. Otherwise, the configuration is similar to the display device 120.

In this example, the concave mirror element 60s includes a third optical layer 60, a fourth optical layer 70, and an intermediate reflection layer 65. The third optical layer 60 has a fifth major surface 60a and a sixth major surface 60b on the opposite side to the fifth major surface 60a. The sixth major surface 60b has a mirror protrusion 61 having a curved surface and a plurality of mirror convexities 62 provided around the mirror protrusion 61. The third optical layer 60 is transmissive to light.

The fourth optical layer 70 has a seventh major surface 70c opposed to the sixth major surface 60b and an eighth major surface 70d on the opposite side to the seventh major surface 70c. The fourth optical layer 70 is transmissive to light. The seventh major surface 70c has a mirror recess 71 recessed along the shape of the mirror protrusion 61 and a plurality of mirror concavities 72 provided around the mirror recess 71. The shape of each of the plurality of mirror concavities 72 conforms to the shape of each of the plurality of mirror convexities 62.

The intermediate reflection layer 65 is provided between the sixth major surface 60b and the seventh major surface 70c. The intermediate reflection layer 65 reflects at least part of the light traveling from the fifth major surface 60a toward the sixth major surface 60b.

The design parameters of the concave mirror element 60s may be set to substantially the same as the design parameters of, for example, the optical unit 10s.

Also the display device 112 can provide an easy-to-view, small, light display device.

### Second Embodiment

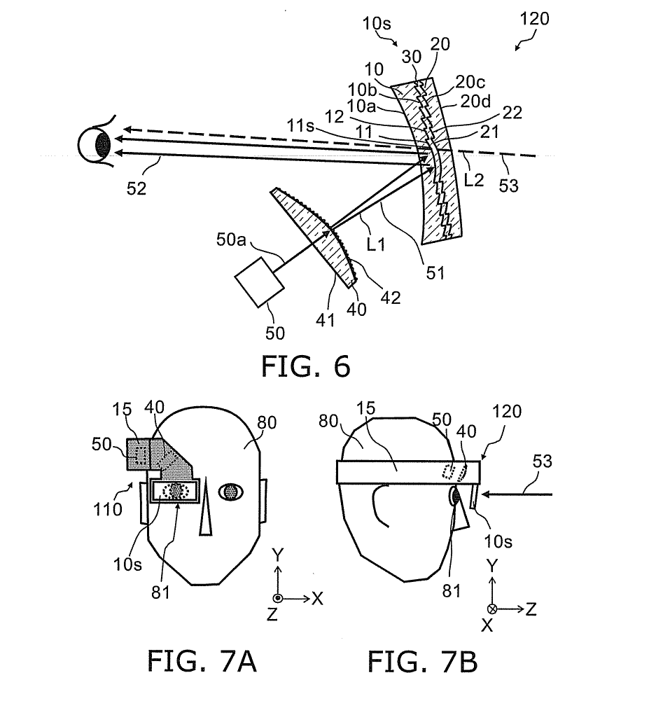

FIG. 6 is a schematic view illustrating a display device according to a second embodiment.

FIG. 7A and FIG. 7B are schematic views illustrating the display device according to the second embodiment.

FIG. 7A is a front view, and FIG. 7B is a side view.

As shown in FIG. 7A and FIG. 7B, a display device 120 according to the embodiment includes the image projection unit 50, a diffusion element 40, the optical unit 10s, and the mounting unit 15.

The configurations of the image projection unit 50, the optical unit 10s, and the mounting unit 15 may be similar to those described in regard to the first embodiment, and a description is therefore omitted.

The mounting unit 15 holds the image projection unit 50, the diffusion element 40, and the optical unit 10s. Also in this case, the viewer 80 can view the background image included in the transmitted light 53 transmitted through the optical unit 10s. The display device 120 is, for example, an optical see-through head-mounted display device.

FIG. 6 illustrates cross sections of the diffusion element 40 and the optical unit 10s.

As shown in FIG. 6, the mounting unit 15 holds the image projection unit 50, the diffusion element 40, and the optical unit 10s so as to allow the image light 50a emitted from the image projection unit 50 to pass through the front surface 42 of the diffusion element 40 and enter the optical unit 10s from the first major surface 10a. Further, the mounting unit 15 determines the relative positional relationship between the optical unit 10s and the eye 81 of the viewer 80 so that the reflected light 52 obtained by the reflection of the image light 51 entering the optical unit 10s at the intermediate layer 30 may be emitted from the first major surface 10a and be incident on the eye 81 of the viewer 80.

The diffusion element 40 has a front surface 42 in a convex curved surface shape. The diffusion element 40 is diffusible to light. The front surface 42 is a convex curved surface. Concavity and convexity is formed at the front surface 42, and thereby the front surface 42 scatters light. In addition, a layer containing fine particles is formed in the front surface 42, and thereby the front surface 42 scatters light. The diffusion element 40 has a back surface 41 on the opposite side to the front surface 42. The back surface 41 is not diffusible to light, for example. The diffusion element 40 is transmissive to light. The back surface 41 is a flat surface, a convex curved surface, or a concave curved surface. In the case where the back surface 41 is a curved surface, the curvature of the back surface 41 is lower than the curvature of the front surface 42. The diffusion element 40 has, for example, the lens effect of a convex lens.

The image light 50a is incident on the back surface 41 of the diffusion element 40, and the incident image light 50a is emitted as the image light 51 from the front surface 42. The width of the light flux (the width of the cross section of the light flux taken along a plane perpendicular to the axis of the light flux) of the image light 51 emitted from the front surface 42 is larger than the width of the light flux of the image light 50a incident on the back surface 41. The front surface 42 expands the diffusion angle of the incident light.

The diffusion element 40 has the lens effect of a convex lens and a diffusion effect. Transparent glass, transparent resin, or the like, for example, is used for the diffusion element 40.

In the display device 120, the diffusion element 40 is provided as a diffusion control unit for controlling the diffusion of the image light 50a. By providing the diffusion control unit, the depth of focus is deepened. Furthermore, at the eye 81, a range in which images are seen can be ensured even when there are eye movements.

On the other hand, when a Fresnel half mirror (the optical unit 10s) is used as the eyepiece, the imaging surface of the image projected is warped. If a correction lens is used in order to correct this, the number of parts is increased and the size and weight of the entire device are increased.

In contrast, in the display device 120 according to the embodiment, the diffusion element 40 mentioned above is used as a diffusion control unit. The front surface 42 of the diffusion element 40 is in a convex curved surface shape being diffusible to light. That is, the front surface 42 is made to correspond to the imaging surface of the Fresnel half mirror (the optical unit 10s). Thereby, the distortion of the imaging surface can be suppressed. That is, the front surface 42 is designed to suppress the distortion of the imaging surface. Thereby, the diffusion element 40 functioning as a diffusion control unit suppresses (e.g. cancels) the warpage of the imaging surface due to the Fresnel half mirror (the optical unit 10s).

Thus, a small, light display device capable of providing an easy-to-view display is obtained without using a correction lens.

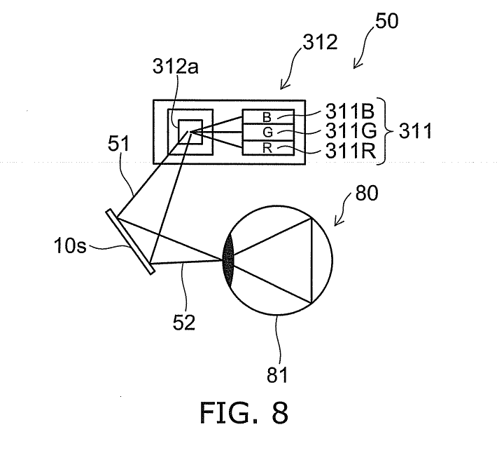

FIG. 8 is a schematic view illustrating a display device according to the embodiment.

FIG. 8 shows an example of the image projection unit 50 that can be used for the display devices 110, 111, 112, and 120 according to the embodiments mentioned above, etc.

In FIG. 8, the diffusion element 40, the diffusion element 67, the concave mirror element 60s, etc. are omitted. In this example, a laser-scanning retinal direct drawing display is used as the image projection unit 50.

As shown in FIG. 8, the image projection unit 50 includes an image engine 312. In this example, the image engine 312 includes a light source 311 (a blue light source 311B, a green light source 311G, and a red light source 311R) and an optical switch 312a.

A blue laser, a green laser, and a red laser are used for the blue light source 311B, the green light source 311G, and the red light source 311R, respectively. A MEMS (micro-electro-mechanical system) scanner, for example, is used for the optical switch 312a.

Brightness-adjusted light is emitted from the light source 311 in accordance with an image signal. The light emitted from the light source 311 is incident on the reflection surface of the MEMS device. The MEMS scanner changes the direction of the incident light. The light reflected at the MEMS scanner is scanned along the horizontal and vertical directions. Thereby, an image is formed.

On the optical path of light, optical elements (the diffusion element 40, the diffusion element 67, the concave mirror element 60s, etc.) and the optical unit 10s are provided between the MEMS scanner and the eye 81 of the viewer 80.

The optical unit 10s reflects the scanned light (image light 51) and causes the reflected light 52 to enter the eye 81 of the viewer 80. Thereby, an image is displayed on the retina surface of the eye 81.

The viewer 80 can view both the actual scene and the display image displayed by the image projection unit 50 through the optical unit 10s. Thereby, the display image is seen to overlap with the actual scene.

The embodiment provides an easy-to-view, small, light display device.

Hereinabove, embodiments of the invention are described with reference to specific examples. However, the embodiment of the invention is not limited to these specific examples. For example, one skilled in the art may appropriately select specific configurations of components of display devices such as image projection units, diffusion elements, concave mirror elements, optical units, first optical layers, second optical layers, intermediate layers, and mounting units from known art and similarly practice the invention. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all display devices practicable by an appropriate design modification by one skilled in the art based on the display devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A display device comprising:
an image projection unit configured to emit an image light including an image;
a diffusion element being diffusible to a light;
a concave mirror element of a Fresnel type;
an optical unit including:
a first optical layer having a first major surface and a second major surface on an opposite side to the first major surface, the second major surface having a protrusion having a curved surface and a plurality of convexities provided around the protrusion, the first optical layer being transmissive to a light;
a second optical layer having a third major surface and a fourth major surface, the third major surface being opposed to the second major surface, the fourth major surface being on an opposite side to the third major surface, the third major surface having a recess recessed along a shape of the protrusion and a plurality of concavities provided around the recess, a shape of each of the concavities conforming to a shape of each of the convexities, the second optical layer being transmissive to a light; and
an intermediate layer provided between the second major surface and the third major surface, the intermediate layer being configured to reflect at least a part of a light traveling from the first major surface toward the second major surface and transmit at least a part of a light traveling from the fourth major surface toward the third major surface; and
a mounting unit holding the image projection unit, the diffusion element, the concave mirror element, and the optical unit so as to allow the image light emitted from the image projection unit to pass through the diffusion element, cause the image light emitted from the diffusion element to be reflected at the concave mirror element, and cause the image light reflected at the concave mirror element to enter the optical unit from the first major surface and configured to determine a relative positional relationship between the optical unit and an eye of a viewer so that a reflected light obtained by reflection of the image light entering the optical unit at the intermediate layer is emitted from the first major surface and is incident on the eye of the viewer.

2. The device according to claim 1, wherein
the convexities are provided around the protrusion in a form of concentric circles and
the concavities are provided around the recess in a form of concentric circles.

3. The device according to claim 1, wherein a distance between two nearest convexities out of the convexities is not less than ½ and not more than 10 times a pitch of a pixel of the image light.

4. The device according to claim 1, wherein a spacing between adjacent convexities along a second direction perpendicular to a first direction from the first major surface toward the second major surface is different from a spacing between adjacent convexities along a third direction perpendicular to the first direction and the second direction.

5. The device according to claim 1, wherein a refractive index of the first optical layer is equal to a refractive index of the second optical layer.

6. The device according to claim 1, wherein an absolute value of a difference between a refractive index of the first optical layer and a refractive index of the second optical layer Is not more than 1×10⁻³.

7. The device according to claim 1, wherein the intermediate layer is a metal film or a metal compound film.

8. The device according to claim 1, wherein a transmittance of the intermediate layer to a light having a wavelength of 550 nm is not less than 90%.

9. The device according to claim 1, wherein the image light is a laser light.

10. The device according to claim 1, wherein a width of a light flux of the image light emitted from the diffusion element is larger than a width of a light flux of the image light incident on the diffusion element.

11. The device according to claim 1, wherein
the concave mirror element has a mirror major surface,
the mirror major surface has
a recess in a concaved curved surface shape, and
a plurality of concavities provided around the recess, and
each of the concavities is provided in a form of a concentric circle with center at a center of the recess.

12. The device according to claim 1, further comprising:
a first lens element provided between the image projection unit and the diffusion element;
a mirror provided between the first lens element and the diffusion element; and
a second lens element provided between the mirror and the diffusion element.

13. The device according to claim 1, wherein a curvature of the first major surface is different from a curvature of the second major surface.

14. The device according to claim 1, wherein
the diffusion element includes
a first lenticular lens having a plurality of first lenticular convexities extending in a first direction, and
a second lenticular lens having a plurality of second lenticular convexities extending in a second direction intersecting the first direction.

15. The device according to claim 14, wherein a pitch of the first lenticular convexities is not less than 75% and not more than 125% of a pitch of a pixel of the image light.

16. The device according to claim 1, wherein
the diffusion element includes a microlens array, and
the microlens array has
a base substance, and
a plurality of lenses provided on a surface of the base substance.

17. The device according to claim 16, wherein a pitch of the lenses is not less than 75% and not more than 125% of a pitch of a pixel of the image light.

18. The device according to claim 16, wherein
the diffusion element further includes a light blocking layer provided between the lenses on the surface of the base substance.

19. The device according to claim 1, further comprising:
a cylindrical lens provided between the concave mirror element and the optical unit on an optical path of the image light.

20. A display device comprising:
an image projection unit configured to emit an image light including an image;
a diffusion element having a front surface in a convex curved surface shape being diffusible to a light;
an optical unit including:
a first optical layer having a first major surface and a second major surface on an opposite side to the first major surface, the second major surface having a protrusion having a curved surface and a plurality of convexities provided around the protrusion, the first optical layer being transmissive to a light;
a second optical layer having a third major surface and a fourth major surface, the third major surface being opposed to the second major surface, the fourth major surface being on an opposite side to the third major surface, the third major surface having a recess recessed along a shape of the protrusion and a plurality of concavities provided around the recess, a shape of each of the concavities conforming to a shape of each of the convexities, the second optical layer being transmissive to a light; and
an intermediate layer provided between the second major surface and the third major surface, the intermediate layer being configured to reflect at least a part of a light traveling from the first major surface toward the second major surface and transmit at least a part of a light traveling from the fourth major surface toward the third major surface; and
a mounting unit holding the image projection unit, the diffusion element, and the optical unit so as to allow the image light emitted from the image projection unit to pass through the front surface and enter the optical unit from the first major surface and configured to determine a relative positional relationship between the optical unit and an eye of a viewer so that a reflected light obtained by reflection of the image light entering the optical unit at the intermediate layer is emitted from the first major surface and is incident on the eye of the viewer.
